(19) United States
(12) Patent Application Publication
(10) Pub. No.: US 2026/0279706 A1
(43) Pub. Date: Sep. 17, 2026

(54) UNDERWATER TENSILE ROPE STRESS DETECTION SYSTEM

(71) Applicants: Andrea Angera, Edgartown, MA (US); University of Massachusetts, Westborough, MA (US)

(72) Inventors: Eli Kurtz, Lincoln, MA (US); Michael F. Tlusty, Melrose, MA (US); Andrea Angera, Edgartown, MA (US)

(21) Appl. No.: 19/474,468

(22) PCT Filed: Apr. 8, 2024
(86) PCT No.: PCT/US2024/023613

§ 371 Date: Oct. 10, 2025

Related U.S. Application Data
(60) Provisional application No. 63/495,178, filed on Apr. 10, 2023.

(51) Int. Cl. H01H 36/00; B63B 21/00; B63B 79/10

(52) U.S. Cl. CPC H01H 36/0033; B63B 79/10; B63B 2021/008

(57) ABSTRACT

An underwater line stress detection device includes a piezoelectric transducer; a signal generator circuit; a reed switch operatively coupled to the piezoelectric transducer and the signal generator circuit such that the signal generator circuit drives the piezoelectric transducer when the reed switch is activated; a magnet; and a plunger mechanism, attachable to the underwater line. The plunger mechanism is configured to bias the magnet to the reed switch to deactivate the reed switch when the underwater line is in a non-stressed state; and the magnet and the reed switch to activate the reed switch when the underwater line is in a stressed state.

### CLAIM OF PRIORITY

This application claims the benefit of U.S. Provisional Application No. 63/495,178 filed on Apr. 10, 2023, which is hereby incorporated by reference in its entirety.

### TECHNOLOGICAL FIELD

The present disclosure relates to stress detection systems, and more particularly, but not by way of limitation, to a method and device for monitoring the stress on an underwater line.

### BACKGROUND

Underwater ropes, specifically those used in aquaculture operations, are prone to breakage or large animals such as whales and turtles may be entangled in them. There is currently no effective and inexpensive solution to monitor the tensile stress on these ropes. The invention allows a user to monitor in real time when the tensile stresses on an underwater rope exceed a pre-set stress threshold. This ability allows the user to quickly respond to potentially damaging or destructive events on an aquaculture site.

### SUMMARY

This document describes, among other things, a weak link mechanism design, underwater acoustic transmission, and custom frequency detection software deployed on a monitoring buoy to identify and process transmissions from a sensor node.

The system includes a more power-efficient weak link, redesigned using a magnetic reed switch. The design also incorporates acoustic communication between nodes and a gateway, and custom Python code for detection of target acoustic frequencies. Overall, the system includes continuous remote monitoring, long distance transmission, low cost, multi-node capacity, and ease of use.

In communicating from multiple nodes to the monitoring buoy, each node will use a slightly different frequency band, for example the second node might use 20.2 KHz. In this way, the signal received by the buoy can be associated with a particular node and therefore with a particular node being monitored.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 is a diagram of an example of an underwater line stress detection system.

FIG. 2 shows an example of weak link case halves magnetically connected.

FIG. 3 shows an example of weak link case halves separated.

FIGS. 4 and 5 show examples of a plunger mechanism.

FIG. 6 shows an example of a sub-assembly of the plunger mechanism positioned at the top of the node circuitry system.

FIGS. 7 and 8 show examples of a front view of the encased node circuitry system after epoxy.

FIG. 9 shows an example of the node circuitry system with batteries before epoxy.

FIG. 10 shows an example of a front view of the encased node circuitry system before epoxy.

FIG. 11 is a flow diagram of an example of a method of detecting stress on an underwater line.

### DETAILED DESCRIPTION

The present disclosure relates to a stress detection system for monitoring the stress on an underwater line. Acoustic communication in oceanic sensor networks include sensor networks for the aquaculture industry. The present inventors have recognized that a need for improvement upon the use of acoustic sensor nodes which communicate with a central hub that then uses radio frequency (RF) communication to transmit signals to a base station.

This disclosure describes, among other things, a design and method containing a weak link mechanism design, underwater acoustic transmission, and custom frequency detection software deployed on a monitoring buoy to identify and process transmissions from a sensor node.

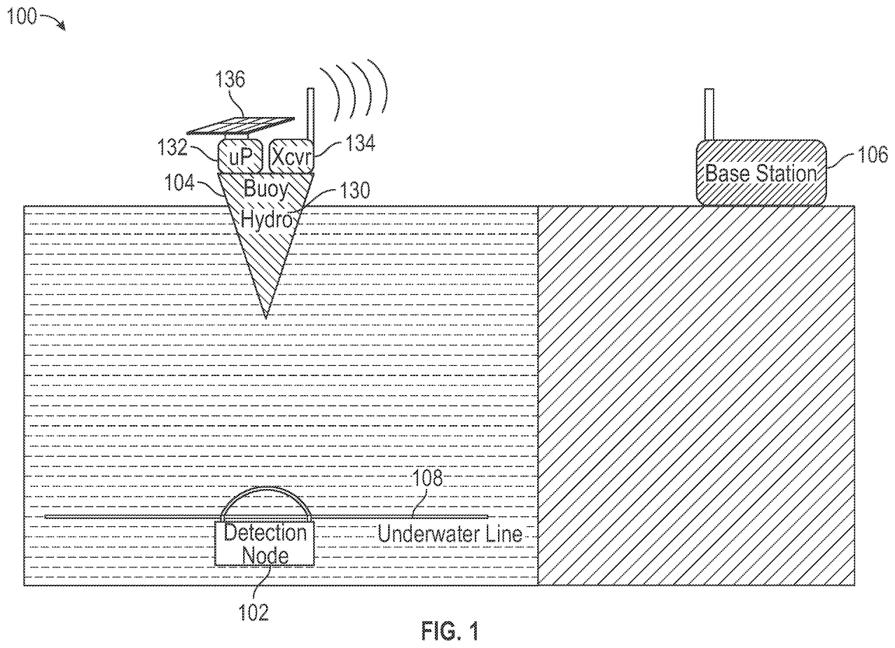

FIG. 1 is a drawing is a drawing of an example of an underwater line stress detection system 100 to detect and notify when an underwater rope or line is under tensile stresses that may cause damage. The system 100 includes a stress detection node 102, that detects the stress on the underwater, a monitoring device 104 included in a monitoring buoy, and a base station 106 to receive signals from the monitoring device 104. The system 100 may monitor multiple underwater lines using multiple stress detection nodes 102, and more than one stress detection node 102 may be used to monitor one underwater line 108.

The stress detection node 102 includes a weak link that includes a reed switch. The weak link is used to detect a level of stress on the underwater line 108 that is more than normal stress on the line but lower than an amount of stress that will damage the underwater line. The weak line is designed to separate before the stress increases to an amount that will damage the underwater line. The weak link includes a reed switch and a magnet.

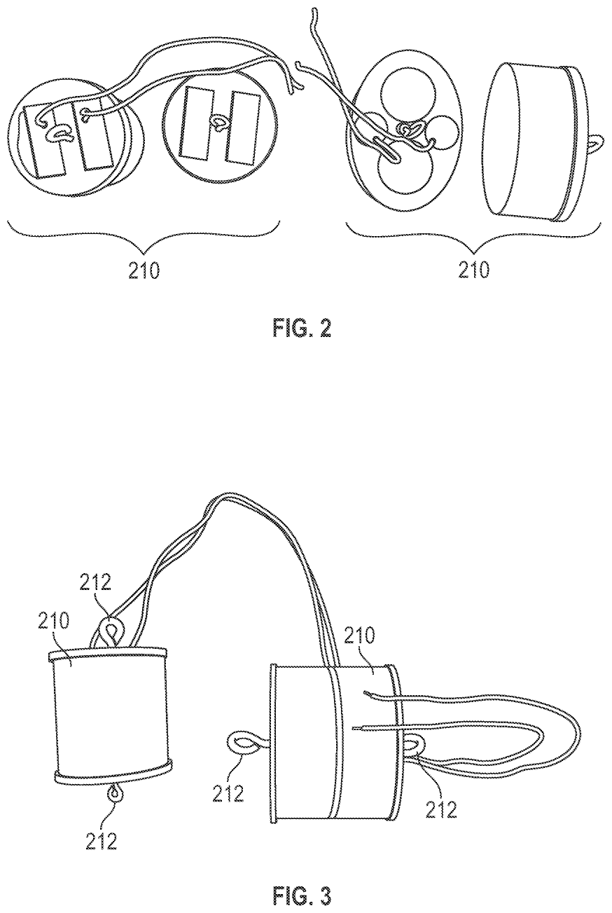

FIGS. 2 and 3 depict examples of weak links or the stress reduction node. FIG. 2 shows the two weak links 210 separated, and FIG. 3 shows the two weak links 210 connected magnetically. The weak links utilize a Normally Closed (NC) reed switch within the weak link so that current only flows under stress events. A reed switch is an electrical switch device that can be opened or closed by the proximity of a magnetic field. It can be configured in two states: Normally Open (NO) and Normally Closed (NC). In Normally Open state, the switch is open and no current flows, until it is brought in contact with a magnetic field, whereupon the switch closes and current may flow through the switch for as long as the magnetic field persists. A Normally Closed switch is the inverse: the switch is closed and current passes through until the introduction of a magnetic field, which opens the switch and causes the flow of current to cease. In the current system, the elongation of the weak link mechanism will pull a magnet away from a NC switch causing current to flow and trigger a transmission to shore.

Though the switches are generally not waterproof, the switch can be encased in epoxy to extend their underwater life. Using waterproof materials or methods of printing, for example, 3D printing, molds can be developed to hold each half of the reed switch which can then be filled with a waterproof epoxy. In an example, strong neodymium magnets can be inserted into each half of the mold, allowing the two halves to stay connected and withstand a higher tensile force through the magnetic attraction between the two halves.

In an embodiment, two eye bolts 212 may be inserted into the mold to act as attachment points to the long line. This design may be successful at stopping and starting the flow of current through the switch. The normally closed reed switch may be positioned so that the action of a spring would serve both to moderate the tension force needed to trigger the weak link as well as automatically reset the weak link after a break.

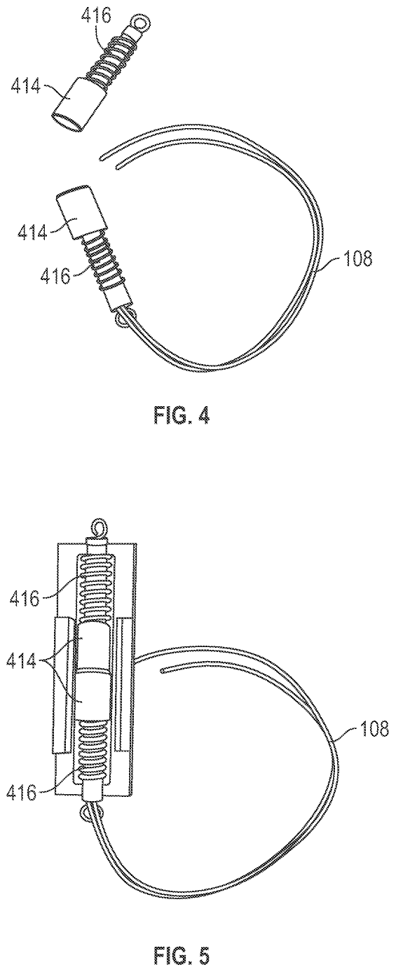

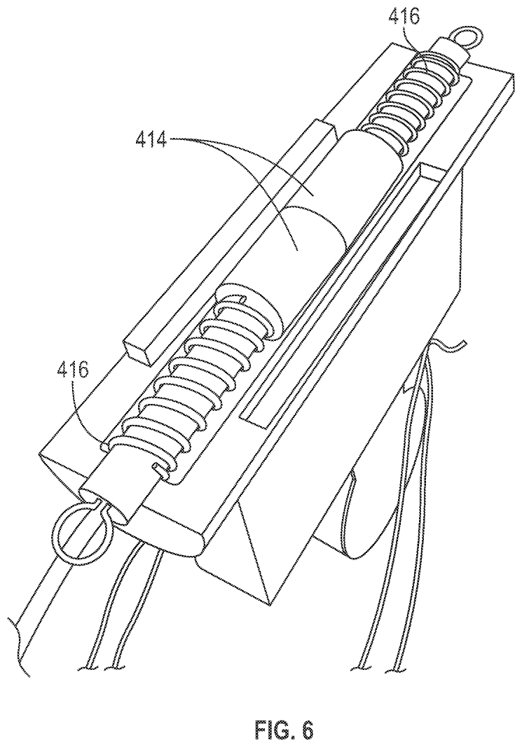

FIGS. 4 and 5 show plunger mechanisms used in the weak links that are used to bias the magnet and the reed switch together and allow for the desired amount of force to separate the magnet and the reed switch. As shown in FIG. 4 and FIG. 5, a plunger 414 and spring 416 method of construction embeds the magnet and the reed switch in two plunger-style components which are positioned facing each other. The magnet is within the head of one plunger 414 while the reed switch is within the other plunger 414. FIG. 4 shows the plunger mechanisms separated, and FIG. 5 shows the plunger mechanisms together.

FIG. 6 shows that a spring 416 surrounds the shaft of each plunger 414 and the springs 416 apply a compression force to the plungers 414 to bias the plungers 414 together so that the magnet keeps the reed switch deactivated in a normal non-stressed state of the underwater line.

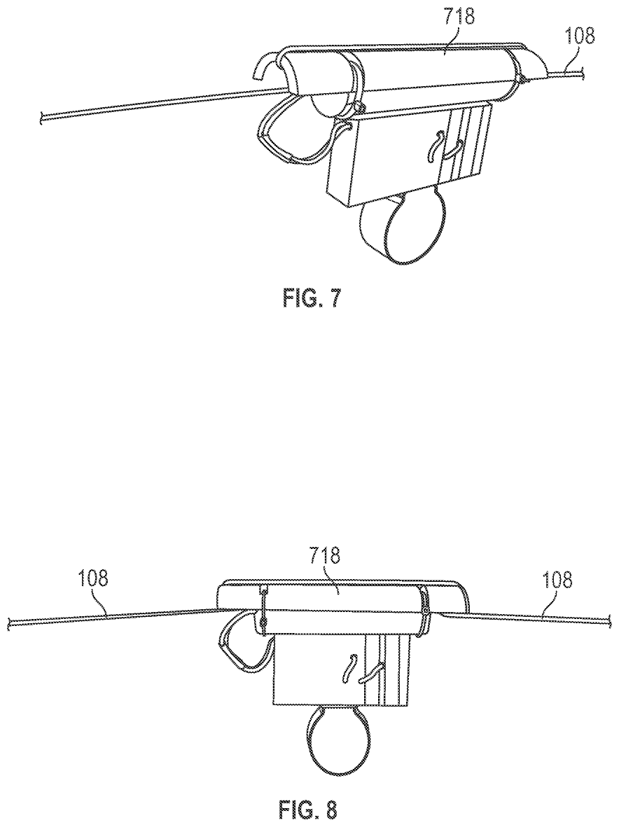

FIGS. 7 and 8 show that both the plungers 414 and springs 416 are then enclosed by a tight clam shell-style case 718 which allows the plungers 414 to be pulled apart against the compression of the springs 416. A short section of the line is looped around each half of the plunger mechanism and a short section of the underwater line reaches from one end of the plunger mechanism to the other end of the plunger mechanism. Stress on the long portion of the underwater line 108 pulls the against the springs to pull the two halves of the plunger mechanism apart. If the user of the stress detection nodes 102 desires to change the force at which the weak link separates and alarms, these springs 416 could be switched out in favor of springs with the desired stiffness.

The plungers 414 and case 718, as shown in FIGS. 7 and 8, may be constructed by, for example, 3D printing. In an example, the plunger 414 may be created as a hollow mold and filled with 2-part epoxy to strengthen it. An eye bolt 212 may also be added to the end of each plunger 414 to aid attachment to a long line. As tension in the long line increases, the plungers 414 are pulled far enough away from each other such that the reed switch closes and current flows to the detection equipment. When the tension force lessens, the springs move the magnet and switch back into contact, opening the switch and halting the flow of current.

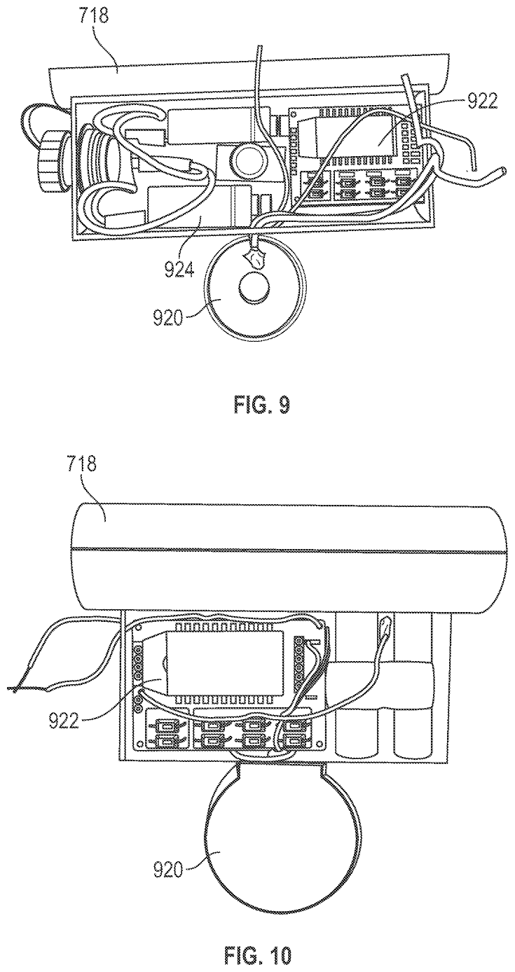

FIGS. 9 and 10 show two views of the weak link mechanism that includes an underwater acoustic sound projector and associated components 922 may comprise a node circuitry system in a stress detection system. The node circuitry system is small and self-contained so as to be deployed underwater for extended periods. In an example small 15V, 60 mAh batteries 924 are used. The relatively high voltage provided by the batteries is useful in this application, as a higher voltage differential across the poles of a piezoelectric element 920 (e.g., the Lead Zirconate Titanate (PZT) element) translates into a louder sound produced. In an example, the batteries may be placed in series to increase the voltage. Rechargeable 9V batteries wired in series may also be used as shown in FIG. 9. Optionally, the node circuitry system may include a waterproof USB port embedded into the node circuitry system for charging access.

When the reed switch is closed by tension in the line, current from the batteries 924 runs through the reed switch to a square wave signal generator included in the components 922. A square or sine wave may be used, however, a square way can be a low cost way for exciting the piezoelectric element 920 due to low cost of square wave generator chips as well as the higher power efficiency they can achieve in driving the piezoelectric element 920. In an embodiment, the square wave generator component modulates the electrical output of the batteries 924 through two wires such that the voltage output of one wire is high while the other is low. The frequency of switching the low and high voltage of the wires is the frequency of the acoustic waves output by the element. Several different square wave signal generators may be used. For example, the HiLetgo signal generator board with an LCD display can produce a square wave signal frequency from 1 Hz-150 KHz.

In an embodiment, the electrical components are potted using an insulant or sealant, for example, Epoxy Seal 9000, which is designed specifically for electronic components. The electrical components as well as the reed switch plunger, spring sub-assembly, and the PZT element may all be contained in a specifically designed case, for example, one designed by 3D printing. Upon assembly of the components, the entire node circuitry system may be placed underwater, and the two ends of the plunger assembly are attached to the long line, spanning an area of low tension.

When a stressed state of the underwater line separates the plunger halves and the acoustic frequency is generated by the node circuitry system, the frequency is detected by a monitoring gateway that monitors the stress detection nodes 102 of the system. Returning to the example of FIG. 1, the gateway is a hydrophone 130 of a monitoring buoy. A H1a hydrophone 130 may be used in the monitoring buoy. The hydrophone 130 may be a passive device, and the input requires amplification and processing before any action may be taken based on received signal. In an example, the hydrophone monitoring buoy may be made up of 4 main parts: the hydrophone and amplifier, a processor 132, and a transceiver 134 (e.g., LoRa radio communication equipment) to transmit information to the base station 106.

Most acoustic modems work by modulating the frequency of their acoustic output based on a principle such as Frequency Shift Keying (FSK) or Phase Shift Keying (PSK). The receiver then de-modulates the received signal according to the keying method. In this manner a modem can transfer data using acoustic waves, hence the name modem (modulator-demodulator). Modulation may produce a tone at a given frequency. Given the nature of the monitoring, in an example, only a binary signal is used. The monitoring buoy 104 may be set to continuously scan the data from the hydrophone 130 for the presence of a certain acoustic frequency which the node circuitry system is pre-set to generate when under stress. If detected at a sufficient strength level, the processor 132 activates the transceiver 134 indicating the high-tension event or stressed state of the underwater line occurring in real time.

The processor 132 of the monitoring buoy may comprise a Raspberry Pi (RPi) 4 microcomputer. The RPi conducts all signal processing, powers the other devices, and activates the transceiver 134 when called. The monitoring device 104 may include an audio card, for example, a Pisound device is connected to the RPi. The Pisound is “an ultra-low latency high-quality sound card and MIDI interface specially designed for Raspberry Pi pocket computers” (Blokas.io). It has a 6.35 mm stereo jack input that allows for the Hla hydrophone to be connected directly to it. The Pisound provides the necessary signal amplification for the RPi to perform accurate processing routines, and it is capable of sampling rates up to 192 KHz which are more than sufficient for this application. In an example, an Arduino Uno with a Dragino LoRa transceiver shield may also be connected to the RPi via a cable, such as a USB cable. The connection to this transceiver shield affords the Arduino LoRa communication abilities. The RPi is then able to dispatch radio communications by controlling this Arduino using a serial connection. The hardware may be housed in a waterproof enclosure.

Powering the hardware may be done through a 5V, 3 A range wall power adapter connected to the Raspberry Pi. Ranges may vary. When deployed on a remote buoy, a solar charger 136 and rechargeable battery system may be employed to supply these power requirements.

The goal of the hydrophone monitoring buoy 104 is to detect the acoustic frequency produced by the stress detection node circuitry system. To do this, the monitoring buoy 104 may have an accurate spectral read-out of the ocean environment. The Raspberry Pi (RPi) may receive amplified signal through the hydrophone and audio card. In an example, the signal is the input on a custom Python 3 program running on the RPi. The program samples the audio stream from the hydrophone at, for example, a rate of 48 KHz. For example, due to the Nyquist rate, Nᵣ=2B, this gives an effective spectral range of 0-24 KHz. A Fast Fourier Transform (FFT) may be computed on each sample, which breaks the signal down into constituent frequencies and their amplitude. This allows the querying of the amplitude of any frequency within a spectral range.

In an example, the acoustic frequency that a node circuitry system produces is 20 KHz. This 20 KHz number can be supplied to the Python program prior to deploying, along with an amplitude threshold for transmitting an event detection alert. The monitoring buoy may then continuously scan the acoustic data supplied by the hydrophone for the 20 KHz frequency. When first deployed, the monitoring buoy may take baseline readings of the ocean environment and store the ambient condition readings so as not to falsely alert on background noise. However, if the target frequency becomes present above a previously specified threshold amplitude, the RPi may trigger an action such as transmitting a “weak link under stress” message using its LoRa capabilities. In an example, the LoRa base station on shore then receives this transmission and displays it on a connected display. From here, any number of operations could be performed, including text message alerts to the user, data logging, and more. Using this method, the system is effectively able to detect target frequencies underwater.

The acoustic communication between the node circuitry system and hydrophone buoy may take place over the 20 KHz channel. This frequency may be selected for the following reasons. First, due to the limited processing power of the RPi, sampling at a rate of higher than 48 KHz is less desirable for this application. This leaves a range of 0-24 KHz from which to select. Second, 20 KHz is above the frequency of noise generated by most boat traffic (20-500 Hz) (Benson et al., 2010), but also lower than the frequencies used by most fish finders on commercial vessels (50-200 KHz).

Two different PZT transducer shapes (e.g., tube and ring) may be potted in waterproof epoxy. In an example, the elements may be connected to an Analog Discovery 2 USB Oscilloscope, which allows excitation with different frequencies of square waves. In an example, the element is excited using 5 volts. In another example, 20 KHz, which performs better overall, was capable of being detected at over 60 feet using either element. Background noise across each frequency was negligible. In an example, the actual node circuitry transmits using between 18 and 30 volts.

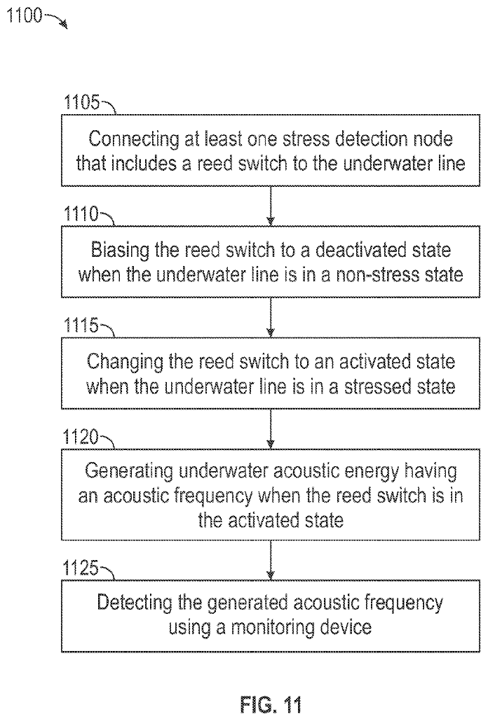

For completeness, FIG. 11 is a flow diagram of an example of a method 1100 of detecting stress on an underwater line. The method 1100 may be performed using the underwater line stress detection system 100 of FIG. 1. At block 1105, at least one stress detection node is connected to the underwater line. The stress detection node includes a reed switch. The reed switch may be a normally closed reed switch in which the reed switch is in an active state and conducts current unless a magnetic field is present. Presence of a magnetic field causes the reed switch to open to an inactive state and stop conducting current.

At block 1110, the reed switch is biased to a deactivated state that does not conduct current when the underwater line is in a non-stressed state. The biasing is provided by a force that holds the reed switch to a magnetic that provides the magnetic field. The biasing may be provided by a spring compression force of a plunger and spring mechanism to hold the reed switch to the magnetic.

At block 1115, the state of the reed switch is changed to an activated state that conducts current when the underwater line is in a stressed state. The stressed state of the underwater line may overcome the compression force to separate the reed switch and magnet, and move the reed switch away from the magnetic field.

At block 1120, the stress detection node generates underwater acoustic energy having an acoustic frequency when the reed switch is in the activated state and conducts current. The acoustic energy may be generated by providing the current from the reed switch to a transducer of the stress detection node positioned underwater.

At block 1125, the acoustic frequency is detected using a monitoring device. The monitoring device may include a hydrophone positioned underwater to detect the acoustic frequency produced by the stress detection node. The monitoring device may transmit an indication of the detected stressed state of the underwater line to another device.

In some examples, the monitoring device monitors multiple stress detection nodes. Each detection node may produce a different acoustic frequency, such as by driving the transducer using a different signal frequency. The difference in the frequencies may be recognized by the monitoring device such as by filtering for example. This makes the acoustic energy from a specific stress detection node to be unique form another stress node. The indication from the monitoring device may include an identifier of the stress detection node producing the acoustic energy as a result of stress on the underwater line.

The systems, devices, and methods described herein provide an effective and inexpensive means to monitor underwater lines that provide structure for aquaculture operations.

### ADDITIONAL DESCRIPTION AND EXAMPLES

A first Example (Example 1) includes subject matter (such as an underwater line stress detection device) comprising a piezoelectric transducer, a signal generator circuit, a reed switch operatively coupled to one or both of the piezoelectric transducer and the signal generator circuit, a magnet, and a plunger mechanism attachable to the underwater line. The signal generator circuit drives the piezoelectric transducer when the reed switch is activated. The plunger mechanism is configured to bias the magnet to the reed switch to deactivate the reed switch when the underwater line is in a non-stressed state and separate the magnet and the reed switch to activate the reed switch when the underwater line is in a stressed state.

In Example 2, the subject matter of Example 1 optionally includes a plunger mechanism that includes a first plunger and a first spring, wherein the magnet is attached to a first end of the first plunger; a first line connector attached to a second end of the first plunger; a second plunger and a second spring, wherein the reed switch is attached to a first end of the second plunger; and a second line connector attached to a second end of the second plunger. The first spring and the second spring bias the magnet to the reed switch.

In Example 3, the subject matter of Example 2, optionally includes plunger mechanism enclosed within a case including two case portions that are separable when in the stressed state and separable against a compression of the first spring and second spring.

In Example 4, the subject matter of one or both of Examples 2 and 3 optionally includes a reed switch and magnet included in a weak link in which the reed switch and magnet are encased in a waterproof mold.

In Example 5, the subject matter of one or any combination of Examples 1-4 optionally includes the reed switch being a normally closed reed switch and presence of a magnetic field prevents current form flowing through the reed switch.

In Example 6, the subject matter of one or any combination of Examples 1-5 optionally includes a neodymium magnet.

In Example 7, the subject matter of one or any combination of Examples 1-6 optionally includes rechargeable batteries to provide energy to the reed switch and signal generator circuit.

In Example 8, the subject matter of one or any combination of Examples 1-7 optionally includes the plunger mechanism positioned along a topside of the piezoelectric transducer and the signal generator circuit.

In Example 9, the subject matter of one or any combination of Examples 1-8 optionally includes a signal generator circuit that produces a square wave signal.

Example 10 includes subject matter (such as a stress detection system) or can optionally be combined with one or any combination of Examples 1-9 to include such subject matter, comprising at least one stress detection node and a monitoring device. The stress detection node includes a piezoelectric transducer, a signal generator circuit, a reed switch operatively coupled to the signal generator circuit, a magnet, and a plunger mechanism attachable to the underwater line. The plunger mechanism is configured to bias the magnet to the reed switch to deactivate the reed switch when the underwater line is in a non-stressed state and separate the magnet and the reed switch to activate the reed switch when the underwater line is in a stressed state. The monitoring device includes a hydrophone and an amplifier configured to detect an acoustic frequency produced by the at least one stress detection node.

In Example 11, the subject matter of Example 10 optionally includes a plunger mechanism including a first plunger and a first spring, a second plunger and a second spring. The magnet is attached to a first end of the first plunger, and a first line connector attached to a second end of the first plunger. The reed switch is attached to a first end of the second plunger, and a second line connector attached to a second end of the second plunger. The first spring and the second spring bias the magnet to the reed switch.

In Example 12, the subject matter of one or both of Examples 10 and 11 optionally include a processor coupled to the amplifier, and a transceiver coupled to the processor. The processor is configured to transmit an indication of an underwater line stress state using the transceiver.

In Example 13, the subject matter of Example 12 optionally includes the monitoring device including a waterproof enclosure containing the hydrophone, processor, amplifier, and transceiver.

In Example 14, the subject matter of one or both of Examples 12 and 13 optionally includes at least one rechargeable battery configured to provide electrical energy to the processor, the amplifier, and the transceiver, and a solar-based battery charging system.

In Example 15, the subject matter of one or any combination of Examples 10-14 optionally includes the at least one stress detection node further including a waterproof enclosure containing the piezoelectric transducer, the signal generator circuit, and the reed switch.

In Example 16, the subject matter of one or any combination of Examples 10-15 optionally includes the signal generator circuit and the piezoelectric transducer of the at least one stress detection node configured to generate acoustic energy with an acoustic frequency of twenty kilohertz (20 KHz) and the hydrophone is configured to detect acoustic energy with the acoustic frequency of 20 KHz.

Example 17 includes subject matter (such as a method of detecting stress on an underwater line) or can optionally be combined with one or any combination of Examples 1-16 to include such subject matter, comprising connecting at least one stress detection node to the underwater line, wherein the stress detection node includes a reed switch, biasing the reed switch to a deactivated state when the underwater line is in a non-stress state, changing the reed switch to an activated state when the underwater line is in a stressed state, generating, by the at least one stress detection node, underwater acoustic energy having an acoustic frequency when the reed switch is in the activated state, and detecting the generated acoustic frequency using a monitoring device.

In Example 18, the subject matter of Example 17 optionally includes biasing a magnet to the reed switch using a first plunger mechanism including a first spring, biasing the reed switch to the magnet using a second plunger mechanism that includes a second spring, and connecting the plunger mechanism to the underwater line.

In Example 19, the subject matter of Example 18 optionally includes separating the magnetic away from the reed switch in response to the stressed state of the underwater line.

In Example 20, the subject matter of one or any combination of Examples 17-19 optionally includes generating an indication of the detected stressed state of the underwater line in response to detecting the generated acoustic frequency.

These non-limiting Examples can be combined in any permutation or combination. The above detailed description is intended to be illustrative, and not restrictive. The scope of the disclosure should, therefore, be determined with references to the appended claims, along with the full scope of equivalents to which such claims are entitled.

1. An underwater line stress detection device, the device comprising:
a piezoelectric transducer;
a signal generator circuit;
a reed switch operatively coupled to one or both of the piezoelectric transducer and the signal generator circuit, wherein the signal generator circuit drives the piezoelectric transducer when the reed switch is activated;
a magnet; and
a plunger mechanism, attachable to the underwater line, the plunger mechanism configured to:
bias the magnet to the reed switch to deactivate the reed switch when the underwater line is in a non-stressed state; and
separate the magnet and the reed switch to activate the reed switch when the underwater line is in a stressed state.

2. The device of claim 1, wherein the plunger mechanism includes:
a first plunger and a first spring, wherein the magnet is attached to a first end of the first plunger,
a first line connector attached to a second end of the first plunger;
a second plunger and a second spring, wherein the reed switch is attached to a first end of the second plunger;
a second line connector attached to a second end of the second plunger; and
wherein the first spring and the second spring bias the magnet to the reed switch.

3. The device of claim 2, wherein the plunger mechanism is enclosed within a case including two case portions that are separable when in the stressed state and separable against a compression of the first spring and second spring.

4. The plunger device of claim 2, wherein the reed switch and magnet are included in a weak link in which the reed switch and magnet are encased in a waterproof mold.

5. The device of claim 1, wherein the reed switch is a normally closed reed switch and presence of a magnetic field prevents current form flowing through the reed switch.

6. The device of claim 1, wherein the magnet is a neodymium magnet.

7. The device of claim 1, further including rechargeable batteries to provide energy to the reed switch and signal generator.

8. The device of claim 1, wherein the plunger mechanism is positioned along a topside of the piezoelectric transducer and the signal generator circuit.

9. The device of claim 1, wherein the signal generator circuit produces a square wave signal.

10. A stress detection system to detect stress on an underwater line, the system comprising:
at least one stress detection node and a monitoring device;
wherein the stress detection node includes:
a piezoelectric transducer;
a signal generator circuit;
a reed switch operatively coupled to the signal generator circuit, wherein the signal generator circuit drives the piezoelectric transducer when the reed switch is activated;
a magnet; and
a plunger mechanism, attachable to the underwater line and configured to bias the magnet to the reed switch to deactivate the reed switch when the underwater line is in a non-stressed state, and separate the magnet and the reed switch to activate the reed switch when the underwater line is in a stressed state; and
wherein the monitoring device includes a hydrophone and an amplifier configured to detect an acoustic frequency produced by the at least one stress detection node.

11. The system of claim 10, wherein the plunger mechanism includes:
a first plunger and a first spring, wherein the magnet is attached to a first end of the first plunger;
a first line connector attached to a second end of the first plunger;
a second plunger and a second spring, wherein the reed switch is attached to a first end of the second plunger,
a second line connector attached to a second end of the second plunger; and
wherein the first spring and the second spring bias the magnet to the reed switch.

12. The system of claim 10, wherein the monitoring device includes:
a processor coupled to the amplifier; and
a transceiver coupled to the processor, wherein the processor is configured to transmit an indication of an underwater line stress state using the transceiver.

13. The system of claim 12, wherein the monitoring device further includes a waterproof enclosure containing the hydrophone, processor, amplifier, and transceiver.

14. The system of claim 12, wherein the monitoring device further includes:
a rechargeable battery configured to provide electrical energy to the processor, the amplifier, and the transceiver; and
a solar battery charging system.

15. The system of claim 10, wherein the at least one stress detection node further includes a waterproof enclosure containing the piezoelectric transducer, the signal generator circuit, and the reed switch.

16. The system of claim 10, wherein the signal generator circuit and the piezoelectric transducer of the at least one stress detection node is configured to generate acoustic energy with an acoustic frequency of twenty kilohertz (20 KHz) and the hydrophone is configured to detect acoustic energy with the acoustic frequency of 20 KHz.

17. A method of detecting stress on an underwater line, the method comprising:
connecting at least one stress detection node to the underwater line, wherein the stress detection node includes a reed switch;
biasing the reed switch to a deactivated state when the underwater line is in a non-stressed state;
changing the reed switch to an activated state when the underwater line is in a stressed state;
generating, by the at least one stress detection node, underwater acoustic energy having an acoustic frequency when the reed switch is in the activated state; and
detecting the generated acoustic frequency using a monitoring device.

18. The method of claim 17,
wherein the biasing the reed switch to the deactivated state includes:
biasing a magnet to the reed switch using a first plunger mechanism including a first spring; and
biasing the reed switch to the magnet using a second plunger mechanism that includes a second spring; and
wherein the connecting the at least one stress detection node to the underwater line includes connecting the plunger mechanism to the underwater line.

19. The method of claim 18, wherein the changing the reed switch to the activated state includes separating the magnetic away from the reed switch in response to the stressed state of the underwater line.

20. The method of claim 17, including generating an indication of the detected stressed state of the underwater line in response to detecting the generated acoustic frequency.
